(19) United States
(12) Patent Application Publication
(10) Pub. No.: US 2009/0222322 A1
(43) Pub. Date: Sep. 3, 2009

(54) MONETIZING A SOCIAL NETWORK PLATFORM

(75) Inventors: Reid Marlow Andersen, Seattle, WA (US); Christian Herwarth Borgs, Seattle, WA (US); Jennifer Tour Chayes, Seattle, WA (US); Kamal Jain, Bellevue, WA (US); Seyed Vahab Mirrokni, Seattle, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/163,247

(22) Filed: Jun. 27, 2008

Related U.S. Application Data
(60) Provisional application No. 61/032,983, filed on Mar. 2, 2008.

(51) Int. Cl. G06F 17/30

(52) U.S. Cl. 705/10

(57) ABSTRACT

A system and/or methodology that exploits user interaction within a social network in order to derive profits. The invention provides for increased flow of money through a social network, and simultaneously allows advertisers and merchants to focus their advertising spending within the social network. Additionally, the invention provides for quantitative measurement of the effects of relational proximity marketing /advertising (RPM), and creates incentives for users to purchase goods through the social network.

### CROSS REFERENCE TO RELATED APPLICATIONS

This application claims priority to U.S. Provisional Patent Application Ser. No. 61/032,983, filed on Mar. 2, 2008, entitled “MONETIZING A SOCIAL NETWORK PLATFORM”, the entirety of which is incorporated herein by reference.

### BACKGROUND OF THE INVENTION

The growth of the Internet, e-commerce, and social networking have increased the pace and volume of wealth accumulation. Companies founded this year may see dynamic growth and profits comparable to companies which have been doing business over much longer periods of time. There are at least two reasons for this. First, businesses on the Internet can scale very quickly, growing to accommodate millions of users in a short time. Second, the networking effect among various entities often creates rapidly expanding markets, in which a company can quickly create and dominant platforms that are extremely profitable.

Two important examples are the search industry and social networking. The search industry has already proven enormously successful, due in large part to an advertising-driven business model. In recent years, online social networks have experienced rapid growth, both in use and variety, but have not yet generated the significant revenue experienced in other areas. Consequently, social networks are not generating revenue commensurate with the amount of user attention, page views, and traffic flow that they have managed to attract.

With the advances in social networking and more particularly in social networking platforms, there is an ongoing and increasing effort to develop and implement effective monetization systems. Current monetization systems include displaying advertisements inside and outside of applications, charging advertisers for applications, selling applications on a subscription basis, and charging commission on digital goods. These techniques are effective basic methods of generating revenue within a publication or website. However, they fail to take full advantage of the social networking paradigm. Social networks are largely driven by the interaction that occurs among the users, and conventional methods neglect this interaction. Therefore, a substantial need exists for a monetization system and/or methodology which exploits user interaction in a social network.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The claimed subject matter relates to a system and/or method for monetizing a social networking platform. In accordance with various aspects of the claimed subject matter, a relation proximity marketing component is associated with a user's profile. The relation proximity marketing component includes a quantifier component that measures the relational proximity of the user to at least one subsequent purchaser of a good.

The display component can exhibit a good the user has purchased or a good the user is using via a display on the user's profile. Additionally, the display component can include a user rating or review of the good, wherein the goods can include physical goods and/or digital goods. Exhibiting the goods on a users profile allows users to entice friends to purchase the same goods.

Merchants can issue a reward to the user based on the relational proximity of the user to at least one subsequent purchaser of a good. Rewards can include micropayments, discounts, or some other incentive for using the relational proximity marketing system.

To the accomplishment of the foregoing and related ends, certain illustrative aspects of the invention are described herein in connection with the following description and the annexed drawings. These aspects are indicative of various ways in which the invention may be practiced, all of which are intended to be covered by the subject invention. Other advantages and novel features of the invention may become apparent from the following detailed description of the invention when considered in conjunction with the drawings.

### BRIEF DESCRIPTION OF THE DRAWINGS

FIG. 1 is a marketplace graph illustrating a network having a one-sided networking effect in accordance with the subject invention.

FIG. 2 is a marketplace graph illustrating a network having a two-sided networking effect in accordance with the subject invention.

FIG. 3 is a marketplace graph illustrating a network having a three-sided networking effect in accordance with the subject invention.

FIG. 4 illustrates a general component block diagram block diagram of a social networking platform in accordance with the subject invention.

FIG. 5 is a marketplace graph illustrating a social networking platform (SNP) is shown.

FIG. 6 is a general component block diagram illustrating a monetization system is illustrated in accordance with an aspect of the present invention.

FIG. 7 is a flow chart illustrating a monetization system in accordance with an aspect of the present invention.

FIG. 7a is a component block diagram block diagram illustrating a user dispersion in accordance with an aspect of the present invention.

FIG. 8 illustrates a system that employs an artificial intelligence component which facilitates automating one or more features in accordance with the subject invention.

FIG. 9 is a schematic block diagram illustrating a suitable operating environment in accordance with an aspect of the subject invention.

FIG. 10 is a schematic block diagram of a sample-computing environment with which the subject invention can interact.

### DETAILED DESCRIPTION OF THE INVENTION

The subject invention relates to a monetization system and/or methodology that can exploit user interaction in a social network in order to derive profits. In particular, a relational proximity marketing component allows users to communicate and display goods they have purchased to other related users within the social network. Additionally, the relational proximity marketing component quantifies the relational proximity between an initial user and subsequent purchasers of the goods, and can issue a reward to the initial user based on the relational proximity.

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component,” “system,” “object,” “model,” “policy,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Furthermore, inference can be based upon logical models or rules, whereby relationships between components or data are determined by an analysis of the data and drawing conclusions therefrom. For instance, by observing that one user interacts with a subset of other users over a network, it may be determined or inferred that this subset of users belongs to a desired social network of interest for the one user as opposed to a plurality of other users who are never or rarely interacted with.

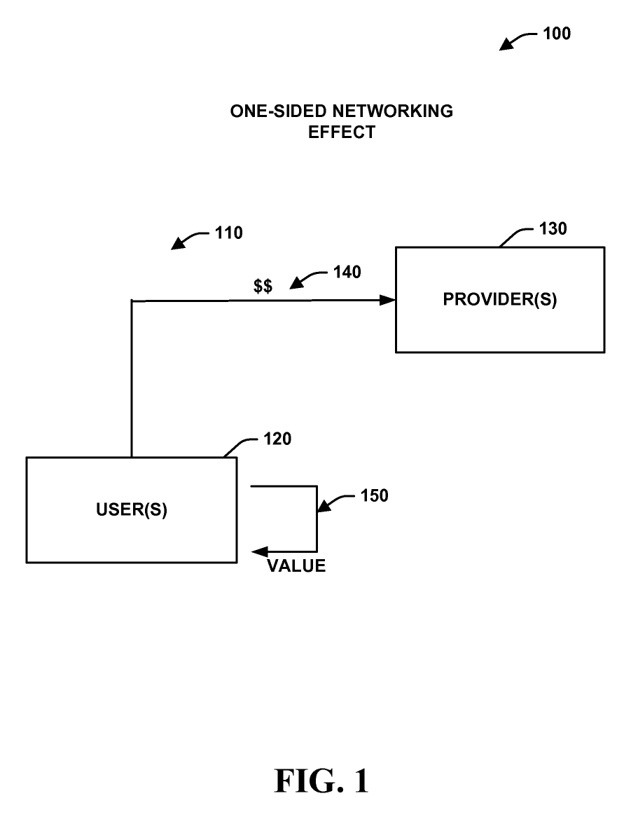

Referring initially to FIG. 1, a marketplace graph 100 is shown illustrating a one-sided networking effect. The marketplace includes a network 110 having one or more users 120 and one or more providers 130. The users 120 make payments 140 to the providers 130 in exchange for a service/good supplied by the providers 130. The network effect is described by the value 150 that a participant in the marketplace gives to other participants, simply by being in the marketplace. In a one-sided network, the value 150 of the service/good supplied by the provider 130 is directly proportional to the number of users 120 in the network. Consequently, the users 120 in a one-sided network 110 add value to the network 110 simply by being in the network 110. For example, word processing software can have a one-sided networking effect. The greater the number of users 120 there are of a compatible and interoperable software suite the greater the value of the software is to every user 120. Telephone networks and cell-phone networks can be another example of one-sided networking effects. When more users 120 have telephones, the utility of every telephone increases. Similarly, most cell-phone carriers provide free in-network calls, because having more users subscribe to a cell-phone carrier makes calls less expensive for everyone on the network 110. In all these cases there is only one side of the network 110, and this side pays for the service/good and simultaneously increases its value.

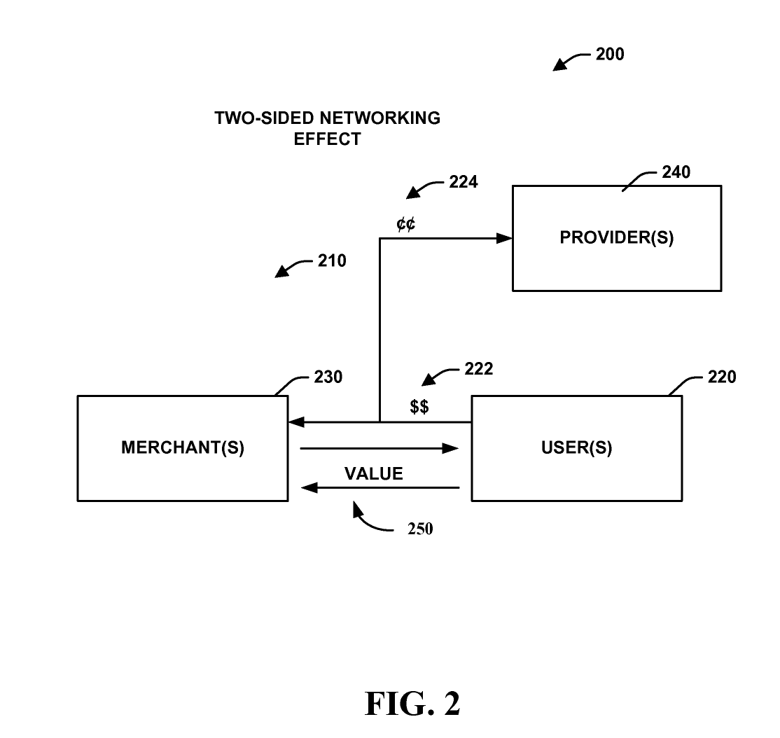

Next referring to FIG. 2, a marketplace graph 200 is shown illustrating a two-sided networking effect. The marketplace includes a network 210 consisting of one or more users 220, one or more merchants 230, and one or more providers 240. In the two-sided network there are two types of entities users 220 and merchants 230 (e.g. buyers and sellers, or credit card holders and merchants, or developers and users), and the value of the network 210 for each entity is proportional to the size of the other side. For example, online auction sites can have a two-sided networking effect. The greater number of users 220 and merchants 230 there are of an online auction site, the greater the value of the site is to every user 220 and merchant 230.

Generally, a marketplace charges fees on money passing through the marketplace. It is often desirable to charge the fees as money leaves rather than enters the marketplace, to avoid discouraging money from entering the marketplace. For example, the flow of money 222 within an online auction site occurs from the users 220 to the merchants 230; therefore the merchants 230 pay the fees (e.g. commission) to the providers 240. Similarly, the flow of money within credit card networks is from the users 220 (e.g. card holders) to the merchants 230; therefore the merchants 230 pay for the use of the credit cards to the credit card provider 240. Additionally, providers 240 can add paid or free add-on services. For example, a credit card provider may charge an annual fee for the ability to earn perks (e.g. frequent flier miles), or may offer credit card holders free perks. Both types of incentives further increase the value of the network for users 220 and thereby for merchants 230 as well.

Additionally, there is a two-sided networking effect for computer implemented platforms as well. One side consists of the developers and the other side consists of the users. If there are more users of a platform, then developers are more likely to develop applications, and if there are more applications, then more users are likely to adopt the platform. As can be seen, the more users and developers there are of a computer implemented platform the greater the value of the platform is to each individual user and developer. Operating System (OS) platforms may appear to be an exception because users pay for the OS, but this is not true in the vast majority of the OS purchases. Most users get a free OS with their hardware. If we put the hardware developers on the developer's side, then these developers pay for the OS. Hardware developers recover the cost of the OS from users by increasing the price of their hardware. A similar phenomenon occurs in any other two-sided market where the price of the good includes the fee of the platform.

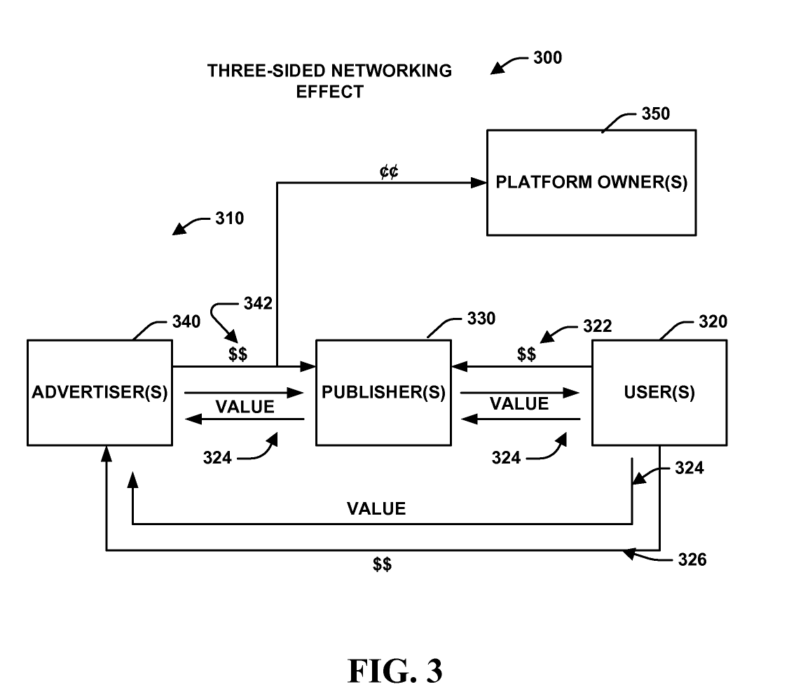

Next referring to FIG. 3, a marketplace graph 300 is shown illustrating a three-sided network. For example, we consider the publication of contextual advertisements on web pages published by a third party. The marketplace includes a network 310 consisting of one or more users 320, one or more publishers 330, one or more advertisers 340, and one or more platform owners 350. In this example, publishers 330 attract users 320 to their websites and show advertisements from the advertisers 340. In return the users 320 may sometimes respond 326 to those advertisements (e.g. clicking through or purchasing goods), and the publisher 330 will receive a commission 342 from the advertiser 340. Again, it is shown that the value of the network 310 for each entity is proportional to the size of the other sides. A large quantity of publishers 330 or publications in the network 310 increases the probability of users 320 being attracted to the network 310. A greater number of users 320 entice advertisers 340 to advertise in the network 310, and so forth.

Examining the marketplace graph 300 and identifying the earning nodes enables the platform owner 350 to determine the flow of money, and at which nodes in the network to charge a fee/commission. The flow of money within the network 310 is from the users 320 to advertisers 340, and advertisers 340 to publishers 330. Looking at the marketplace graph 300 between the users 320 and the advertisers 340, the advertisers 340 are the earning nodes, and it may be desirable for the platform owner 350 to charge the advertisers 340 a fee or commission. Similarly, looking at the marketplace graph 300 between the advertisers 340 and the publishers 330, publishers 330 are the earning nodes. Therefore, the platform owner 350 may also charge a commission on the publisher's 330 earnings. In this way, the platform owner 350 can charge the fees as money leaves the marketplace and can avoid discouraging money from entering the marketplace.

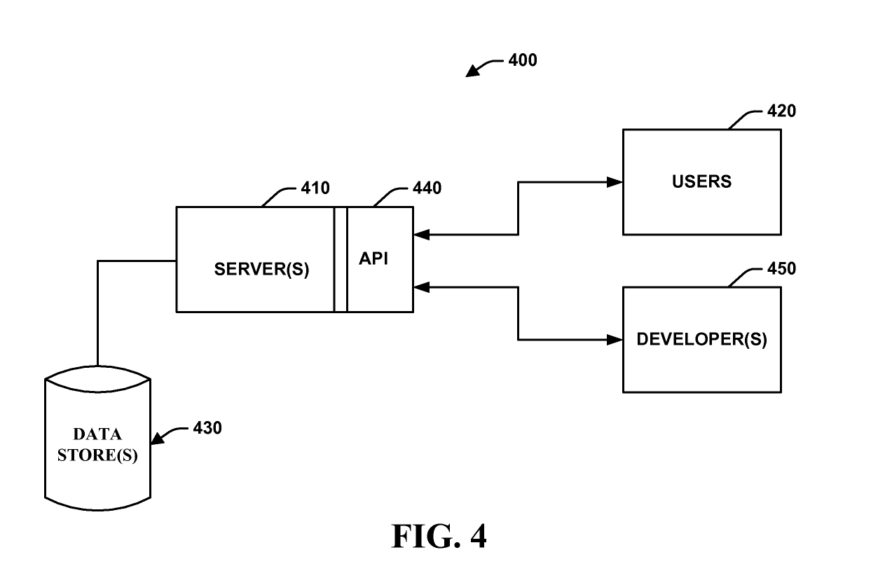

Next referring to FIG. 4, a block diagram illustrating a social networking platform is illustrated in accordance with an aspect of the present invention. The social networking platform (SNP) 400 has a server side component 410, a set of application program interfaces 440 (APIs), a data store 430, a plurality of users 420, and one or more developers 450. The server side component 410 stores profile information of the users 420 in the data store 430. The profile information can be accessed and modified by the APIs 440. The developers 450 can use the APIs 440 to develop new applications for the users 420.

Additionally, the developers 450 can use the APIs 440 to develop client side applications for the users 420. A current issue with social networking is friction on the user 420 side. A user generally has to visit a website to fully enjoy the social network. The client side applications can decrease user friction by making the social network always available (e.g. similar to how Outlook makes email readily available).

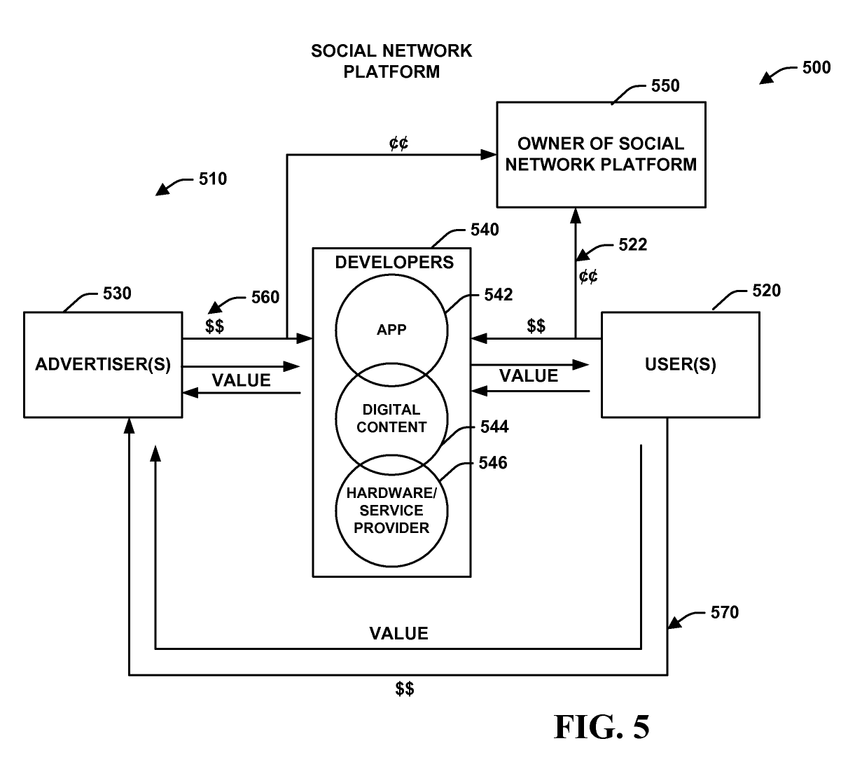

Next referring to FIG. 5, a marketplace graph 500 of a social networking platform (SNP) is shown in accordance with an aspect of the present invention. The marketplace includes a SNP 510, having a plurality of users 520, one or more advertisers 530, one or more developers 540, and a SNP owner 550. The developers 540 in the SNP 510 can be divided into various categories, including but not limited to developers 540 of applications 542, developers 540 of digital goods 544, and developers 540 of hardware/service 546 (e.g. client side applications).

Essentially, the SNP 510 can be thought of as a network similar to those previously discussed, and can contain various kinds of networking effects. The SNP 510 can have a one-sided networking effect among users, similar to word processing software or a telephone network. The utility and value of the social network increases for each user 520 with the greater number of users 520 the social network has as members. The SNP 510 has a two-sided networking effect between developers and users, similar to an OS. Additionally, the SNP 510 has a three-sided networking effect among the users 520, the advertisers 530, and the developers 540, similar to the market for contextual advertisement.

As can be seen by examining the marketplace graph 500, there is a rich variety of monetization systems for the SNP510. Typically, the developers 540 attract users 520 to use their wares, and they monetize their apps 542 by displaying advertisements from the advertisers 530. In return the users 520 may sometimes respond to those advertisements by clicking/purchasing items 570, and the developer receives a commission/fee 560 from the advertiser 530. Additionally, the developers 540 can sell their apps 542 to the users 520 for a small fee, or offer the apps 542 on a subscription basis for premium content. The SNP 510 owner receives a commission from the earning nodes as previously discussed. Furthermore, a developer may choose to make their apps 542 free of advertisements. For example, a developer 540 of apps 542 that provide a service may not want a competitors add to appear in their apps 542. However, in order to keep the apps 542 free of advertisements the developer 540 will have to compensate the SNP owner 550 for the missed earning opportunity. The compensation can be in the form of a page-view fee.

Moreover, some developers 540 sell digital content 544. Obviously, it may be unfeasible or undesirable to display advertisements in some digital content 544. However, the developers 540 charge the users 520 for the digital content 544, and the SNP owner 550 may charge a fee as a commission 522 from the developer 530. One example of the digital content 544 a developer 540 might sell could be an icon expressing a social event (e.g. a birthday gift icon), or charity gift icon, or a social campaign icon. A birthday gift icon is a commercialized icon, and it may be desirable for the SNP owner 550 to charge the developer 530 a commission. A charity organization can create a special icon for a charitable project, (e.g. an earthquake or a flood). A user 520 contributing more than a certain dollar amount earns the right to display the icon in their profile. Examples of social campaign icon could be an organ donor icon or a green earth icon. It may be undesirable for the SNP owner 550 to charge a commission on a charity icon or a social icon. Another example of digital content 544 a developer might sell includes music which can flow through a social network. A user 520 can buy music and place it in their profile. Visitors to the profile page can stream the music from the user's 520 profile page. This can be done by a separate app 542 which could be either a paid app or a free app. Additionally, the user may have to pay an additional fee to move the song to a portable device.

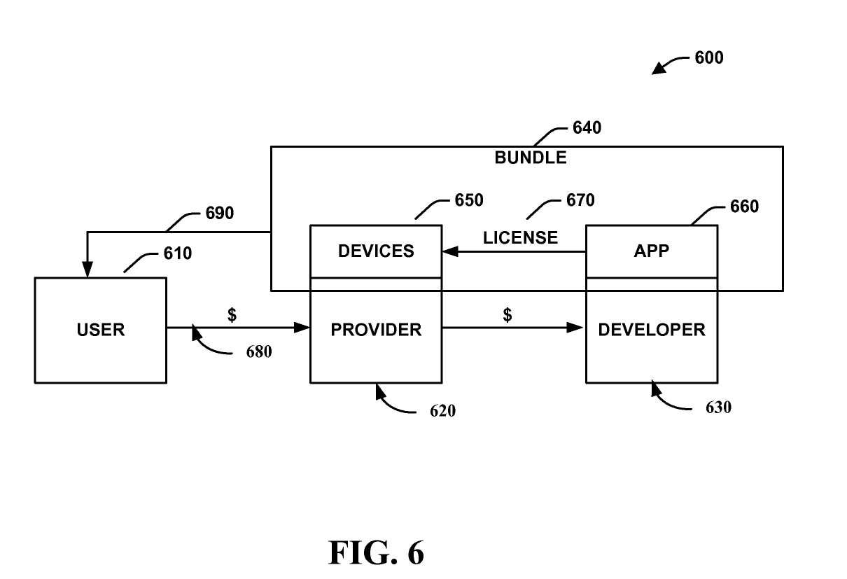

Next referring to FIG. 6, a block diagram of a monetization system is illustrated in accordance with an aspect of the present invention. The bundling system 600 has a user 610, a provider 620, a developer 630, and a bundle 640 including a device 650 and a client side application (app) 660. As previously discussed, a social network can have a two-sided networking effect between developers 630 and users 610, similar to an OS. Therefore, it may be desirable for developers 630 to employ a business model similar to that often used by operating systems. The developers 630 can develop a client side application 660 for the social network that can be included in a bundle 640 with the devices 650 (e.g. laptops, desktops, PDA, handhelds, mobile devices, automobiles, etc.), wherein the provider 620 of the devices 650 pays 670 (e.g. flat fee, licensing fee) the developer 630 for the application 660, rather than having the users 610 pay for the applications 660 directly. The users 610 pay the provider 620 for the application 660 indirectly either in the purchase price 680 of the device 650/bundle 640 or in recurring fees, such as monthly fees.

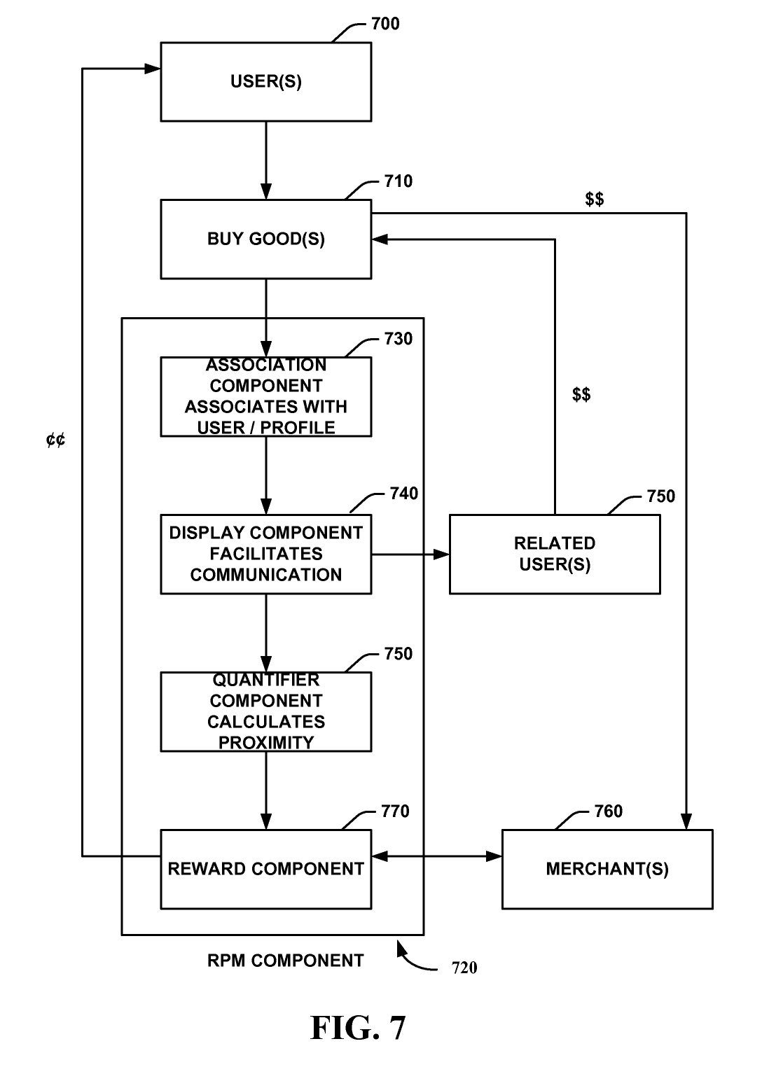

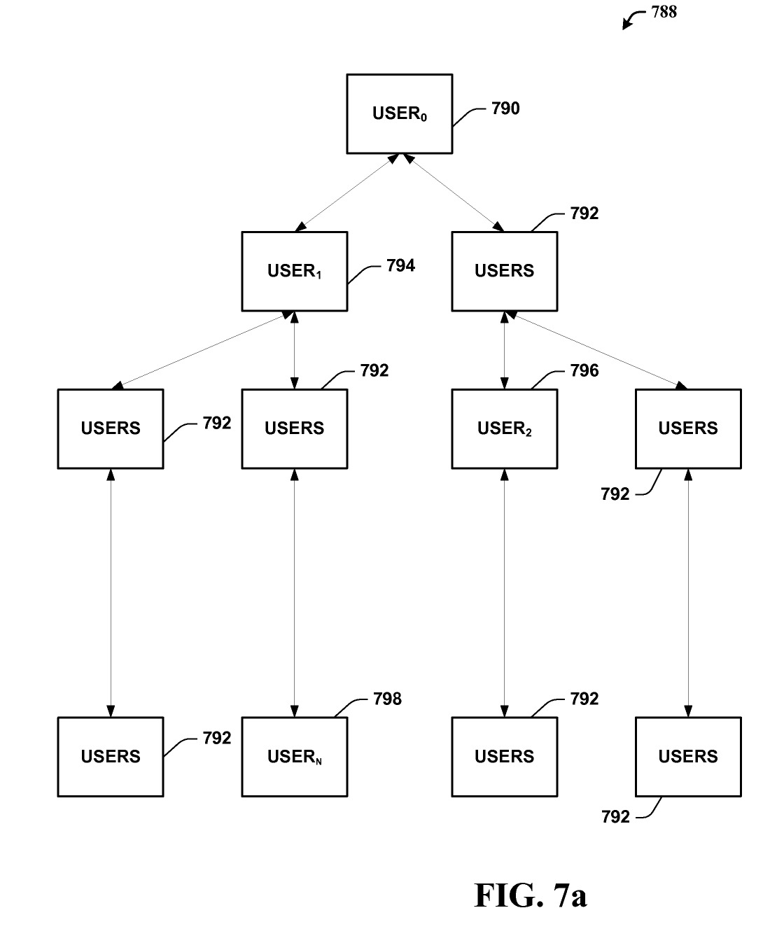

Next referring to FIG. 7, a flow chart of a monetization system is illustrated in accordance with an aspect of the present invention. While, for purposes of simplicity of explanation, the methodologies are shown and described as a series or number of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

At 700 one or more users participate in a social network. The user 700 can purchase goods 710 through a social network. After purchasing the goods 710 the user 700 can elect to participate in a relation proximity marketing (which can be colloquially described as word-of-mouth marketing/advertising or WOMM system). If the user 700 elects to participate in the relation proximity marketing (RPM) system, then a RPM Component 720 is associated with the user 700 and/or their profile via an association component 730. The association component 730 maintains an association between the user and/or user's profile and the RPM component 720. The RPM component can include a display component 740. The display component 740 facilitates communication of data associated with the RPM component (e.g. user purchases) to related users 750. For example, the display component 740 may display a section on the user's 700 profile presenting goods that the user 700 purchased, which in essence shows related users 750 (e.g. friends, additional users with profile viewing privileges) which goods the user 700 has purchased and/or is currently using. The display can further include a user's 700 rating and/or review of the goods.

The RPM component 720 includes a quantifier component 750 that measures the relational proximity of the user 700 to related users 750 who purchased the product after the user 700. The quantifier component can utilize various mathematical models to quantify the relational proximity of subsequent buyers, such as a degree of separation model or a random walk model. For example, a block diagram is shown illustrating a user dispersion in FIG. 7a. For purposes of simplicity of explanation, only users 792 with a vertical relation are considered in this example. The user dispersion includes a network 788 of users 792. The users 792 are represented by nodes on various levels of the network 788, the levels including 0 through N where N is an integer. The relational proximity of a first user 792 to a second user 792 can be quantified by determining which level the first user 792 resides on in relation to the second user 792. The difference between the level of the second user and the level of the first user represents the relational proximity of the users 792 to one another. This can be expressed by the equation:

P=|L(U₂)−L(U₁)|

where P is the proximity and L is the level of a user U. As an example, the relational proximity between an initial user 790 residing on the first level (e.g. 0), and a related user 794 residing on a second level (e.g. 1) equals one. Furthermore, the relational proximity between the initial user 794 and a related user 798 residing on the N^{th} level (e.g. N) is equal to N.

Referring again to FIG. 7, based on the proximity of the user 700 to subsequent purchasers of the goods, a reward component 770 enables a merchant 760 to issue a reward (e.g. retroactive discount) 770 to the user 700. For example, if the reward is a retroactive discount it can be funded at least in part by the marketing savings. The discount issued to the user 700 can be given in terms of micropayments deposited into the user's 700 account. It may be desirable for the merchant 760 to place an upper bound on the total discount, so that the price of the good does not fall below the marginal cost of the product. The discount creates an incentive for the user 700 to make their purchases through the social network. Furthermore, if there is a product which the user 700 expects their friends to buy, the user 700 may obtain a lower purchase price (e.g. discount) by purchasing the product first. When other users nearby in the user's 700 social network purchase that good, the user 700 is obtaining a discount which may be viewed as a referral fee.

Additionally, as discussed supra it is to be understood that the subject invention could be adapted as a client side application or for inclusion therein. Furthermore, the client side application can be bundled with a device, wherein the provider of the device pays (e.g. flat fee, licensing fee) for the application, rather than having the user 700 pay for the application directly. The user pays the provider for the application indirectly either in the purchase price of the device/bundle or in recurring fees, such as monthly fees.

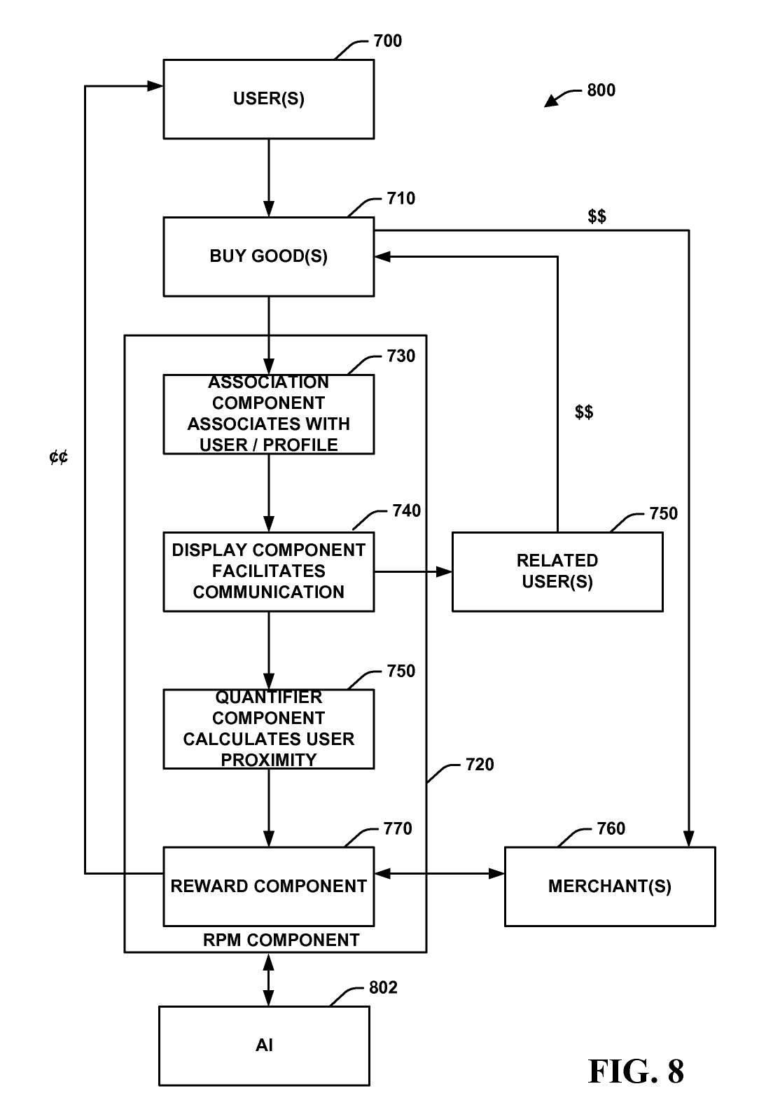

FIG. 8 illustrates a system 800 that employs an artificial intelligence (AI) component 802 which facilitates automating one or more features in accordance with the subject invention. The subject invention (e.g., in connection with inferring) can employ various AI-based schemes for carrying out various aspects thereof. For example, a process for determining a user's 700 participate in the RPM System can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to update or refine the previously inferred schema, tighten the criteria on the inferring algorithm based upon the kind of data being processed (e.g., financial versus non-financial, personal versus non-personal, . . . ), and at what time of day to implement tighter criteria controls (e.g., in the evening when system performance would be less impacted).

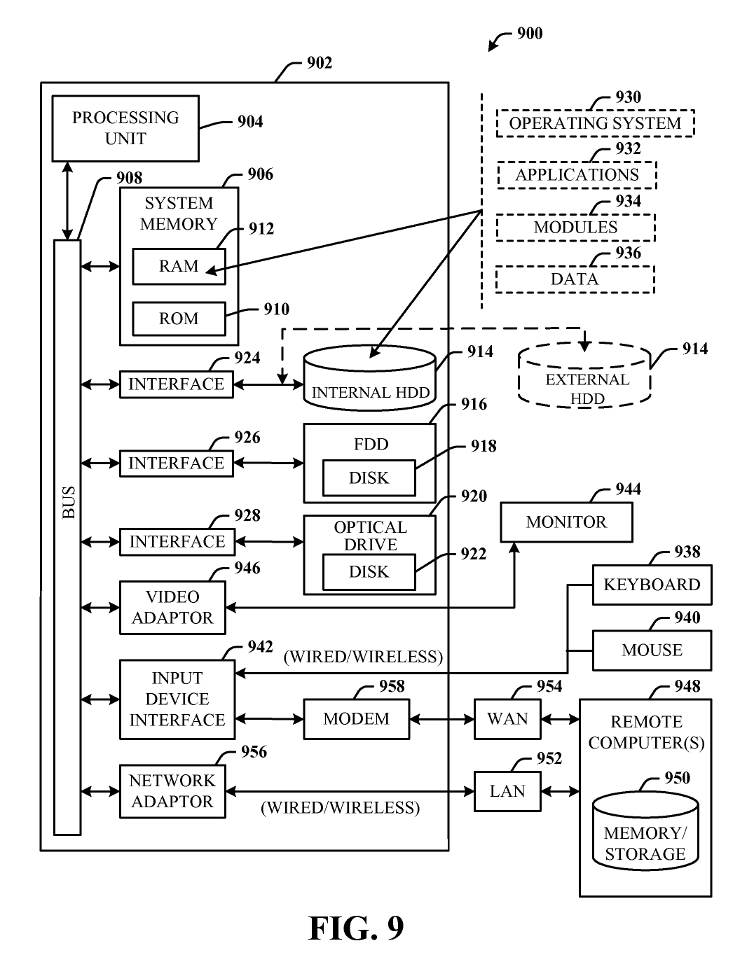

Referring now to FIG. 9, there is illustrated a block diagram of a computer operable to execute the disclosed architecture. In order to provide additional context for various aspects of the subject invention, FIG. 9 and the following discussion are intended to provide a brief, general description of a suitable computing environment 900 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer readable media. Computer readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, there is illustrated an exemplary environment 900 for implementing various aspects of the invention that includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the invention can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices, and companies, and facilitate enterprise-wide computer networks, such as intranets, all of which may connect to a global communication network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

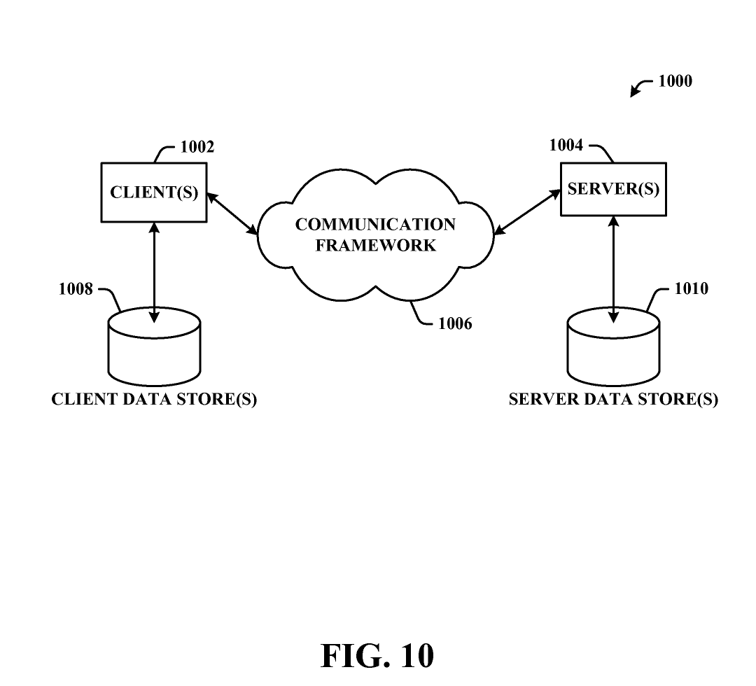

Referring now to FIG. 10, there is illustrated a schematic block diagram of an exemplary computing environment 1000 in accordance with the subject invention. The system 1000 includes one or more client(s) 1002. The client(s) 1002 can be hardware and/or software (e.g., threads, processes, computing devices). The client(s) 1002 can house cookie(s) and/or associated contextual information by employing the invention, for example.

The system 1000 also includes one or more server(s) 1004. The server(s) 1004 can also be hardware and/or software (e.g., threads, processes, computing devices). The servers 1004 can house threads to perform transformations by employing the invention, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A monetization system, comprising:
a relational proximity marketing component that associates with a user's profile, wherein the relational proximity component obtains data regarding at least one good the user has purchased, the data including the identity of the good; and
a quantifier component that measures the relational proximity of the user to at least one subsequent purchaser of the good.

2. The system of claim 1, the quantifier component provides quantitative measurement data of the relational proximity of the user to at least one subsequent purchaser of the good.

3. The system of claim 2, wherein a reward is issued to the user based at least in part on the measurement data.

4. The system of claim 1, wherein the quantifier component measures the relational proximity of the user and the subsequent purchaser based at least in part on at least one of: a random walk model, or a degree of separation model.

5. The system of claim 1, the relational proximity marketing component including a display component that exhibits on the user's profile at least one of: a good the user has purchased, or a good the user is using.

6. The system of claim 5, wherein the display component includes at least one of: a user rating, or user review.

7. The system of claim 1, the good includes at least one of a client side application, a physical good, or a digital good.

8. The system of claim 1, wherein at least one of the relational proximity marketing component, or quantifier component is bundled with a mobile device.

9. The system of claim 1, further comprising an artificial intellingence component that facilitates automating at least one feature of the system.

10. A method for monetizing social networks, comprising:
obtaining marketing data regarding at least one good the user has purchased or is using, the data including at least the identity of the good;
associating the marketing data with a user's profile; and
quantifying a relational proximity of the user to at least one subsequent purchaser of the good.

11. The method of claim 10, further comprising displaying the good on the user's profile.

12. The method of claim 11, further comprising displaying at least one of: a user rating, or user review.

13. The method of claim 11, further comprising displaying the good on the user profile only to associated users.

14. The method of claim 11, wherein the user has purchased the good through the social network.

15. The method of claim 10, further comprising issuing a reward to the user.

16. The method of claim 10, further comprising issuing the reward based at least in part on the quantitative proximity of the user to at least one subsequent purchaser of a good.

17. A computer readable medium having stored thereon the components of the system of claim 10.

18. The system of claim 10, further comprising automating at least one of the steps of claim 10 via artificial intelligence.

19. A system for monetizing social networks, comprising;
means for enabling a user to participate in a relational proximity marketing system;
means for obtaining marketing data regarding at least one good the user has purchased or is using, the data including at least the identity of the good;
means for associating the marketing data with a user's profile;
means for displaying at least part of the marketing data on the user's profile; and
means for quantifying a relational proximity of the user to at least one subsequent purchaser of the good.

20. The system of claim 19, further comprising means for issuing the user a reward based at least in part on the proximity of the user to at least one subsequent purchaser of a good.
